(19) United States
(12) Patent Application Publication
(10) Pub. No.: US 2008/0074838 A1
(43) Pub. Date: Mar. 27, 2008

(54) PORTABLE COMPUTER

(75) Inventor: Peng-Hui Chou, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTEK COMPUTER INC., Taipei (TW)

(21) Appl. No.: 11/850,024

(22) Filed: Sep. 4, 2007

(30) Foreign Application Priority Data
Sep. 25, 2006 (TW) 95135379

(51) Int. Cl. G06F 1/16; A47B 81/00

(52) U.S. Cl. 361/686; 312/223.2

(57) ABSTRACT

A portable computer integrated with a direction button and a game-function button including a main body, a display, a direction button, and a button set for gaming. The direction button and the button set for gaming are respectively provided at the left side and the right side of the main body or the display. Therefore, users may press the directional button or the button set for performing some required functions directly when the users play computer games on the portable computer, thus providing good agileness and portability.

### CROSS-REFERENCE TO RELATED APPLICATION

This application claims the priority benefit of Taiwan application serial no. 95135379, filed Sep. 25, 2006. All disclosure of the Taiwan application is incorporated herein by reference.

### BACKGROUND OF THE INVENTION

1. Field of the Invention

The invention relates to a portable computer and, more particularly, to a portable computer integrated with a direction button and a function button set.

2. Description of the Related Art

In the past, notebooks are only used in business. But since the efficiencies of portable computers have been improved, portable computers gradually supersede desktop computers to be office computers, and even more consumers begin to use notebooks as entertainment devices for seeing a movie, listening to music, playing computer games, or playing online games.

Due to the large market of the computer games and the tendency that the notebook computers supersede desktop computers, many computer companies begin to produce notebook computers dedicated for playing computer games. They are provided with the latest Central Process Unit (CPU), the intermediate or advanced graphics card, and sufficient memory. In addition, some computer companies also produce wide screen notebooks to let users enjoy excellent visual effects when playing games.

At present when playing computer games on notebook computers, users only can use the keys of the keyboard, a touch panel, or a mouse to replace the joystick unit of a game machine for controlling directions or performing specific functions such as “pause” or “a series of actions”. However, due to the small space between the keys of the keyboard of the portable computer and the small height of each key, users can not enjoy the agileness and the effect of the joystick unit of the conventional game machine.

Please refer to FIG. 1, if users have more demands on the agileness of operation and control when playing computer games on the portable computer 100, they need to bring an extra joystick unit 110 and connect it to a port of the portable computer 100, thus users can use the joystick unit 110 to control directions or perform a pause or a series of actions to meet the agileness demand of operation and control. However, the joystick unit has many disadvantages such as large volume, inconvenience of carrying, and so on.

### SUMMARY OF THE INVENTION

The objective of the invention is to provide a portable computer integrated with a direction button and a function button set. The direction button and the button set for gaming are respectively provided at the left side and the right side of the main body or the display to let users enjoy the agileness and the effect of the joystick unit of a conventional game machine and to increase the portability of the notebook computers for gaming.

To achieve the above or other objectives, the invention provides a portable computer integrated with a direction button and a function button set, the portable computer including a main body, a display, a direction button and a button set for gaming. The main body is for processing electronic data and has a keyboard area. The display is pivotally connected to one side of the main body for displaying the output of the electronic data processing. The direction button is provided at the main body, at the surrounding of the keyboard area, and between the keyboard area and the hinge connecting the main body and the display. The button set is provided at the main body and includes a plurality of function buttons, wherein the button set is provided at the surrounding of the keyboard area, and between the keyboard area and the hinge connecting the main body and the display. The direction button and the button set are respectively provided at the two ends of the main body.

In one embodiment of the invention, the portable computer integrated a direction button and a function button set includes a plurality of lateral function buttons provided at the surrounding of the display near the hinge connecting the main body and the display.

In one embodiment of the invention, a first concave portion is provided at the display near the hinge connecting the main body and the display and corresponds to the direction button.

In one embodiment of the invention, a plurality of second concave portions are provided at the display near the hinge connecting the main body and the display and respectively corresponds to the function buttons.

The direction button and the button set described above can be provided between the keyboard area of the main body and the hinge connecting the main body and the display. They also can be provided at the surrounding of the keyboard area of the main body away from the hinge connecting the main body and the display, or at the display near the hinge connecting the main body and the display. Their positions are determined based on the convenience of user operations.

In the portable computer integrated with a direction button and a game-function button of the invention, the direction button and the button set for gaming are respectively provided at the left side and the right side of the main body or the display. Therefore users can press the direction button or the button set for gaming directly for performing the required functions such as controlling direction, attacking or jumping when they play computer games on the portable computer. Therefore, both the agileness and effect of game control and portability of the notebook computer for gaming can be improved.

These and other features, aspects, and advantages of the present invention will become better understood with regard to the following description, appended claims, and accompanying drawings.

### BRIEF DESCRIPTION OF THE DRAWINGS

FIG. 1 is a three-dimensional schematic diagram showing a conventional notebook computer connected with a joystick unit.

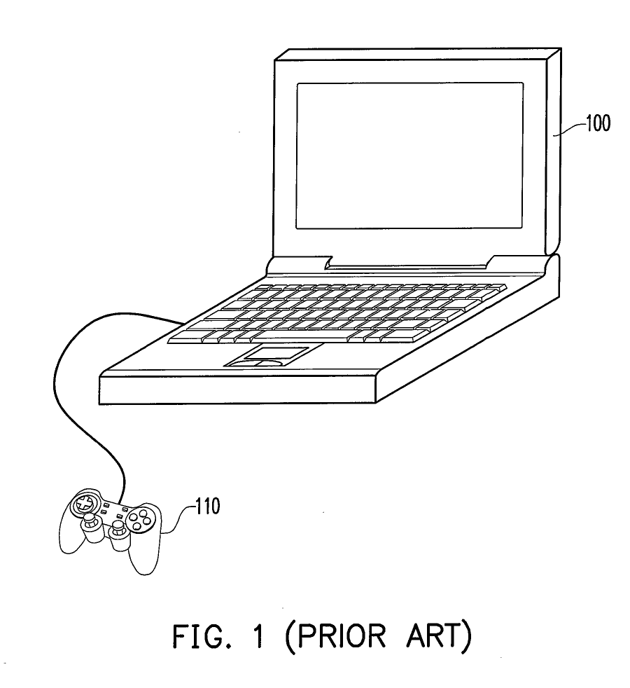

FIG. 2 is a schematic diagram showing a portable computer integrated with a direction button and a game-function button according to the first embodiment of the invention.

FIG. 3 is a schematic diagram showing a portable computer integrated with a direction button and a game-function button in FIG. 2 being used to play computer games.

FIG. 4 is a schematic diagram showing a portable computer integrated with a direction button and a game-function button according to the second embodiment of the invention.

FIG. 5 is a schematic diagram showing a portable computer integrated with a direction button and a game-function button in FIG. 4 being used to play a computer game.

FIG. 6 is a schematic diagram showing a portable computer integrated with a direction button and a game-function button according to the third embodiment of the invention.

FIG. 7 is a schematic diagram showing a portable computer integrated with a direction button and a game-function button in FIG. 6 being used to play a computer game.

### DETAILED DESCRIPTION OF THE EMBODIMENTS

In order to make convenience to let users experience the agileness and the effect of using a joystick of the conventional game machine when playing computer games on the portable computer, the invention integrates the joystick unit to the portable computer by integrating a direction button and a function button set. Therefore users can control directions or perform a pause or a continuous action directly using the direction button and the button set provided on the portable computer without any extra joystick unit. Therefore, the portability is increased.

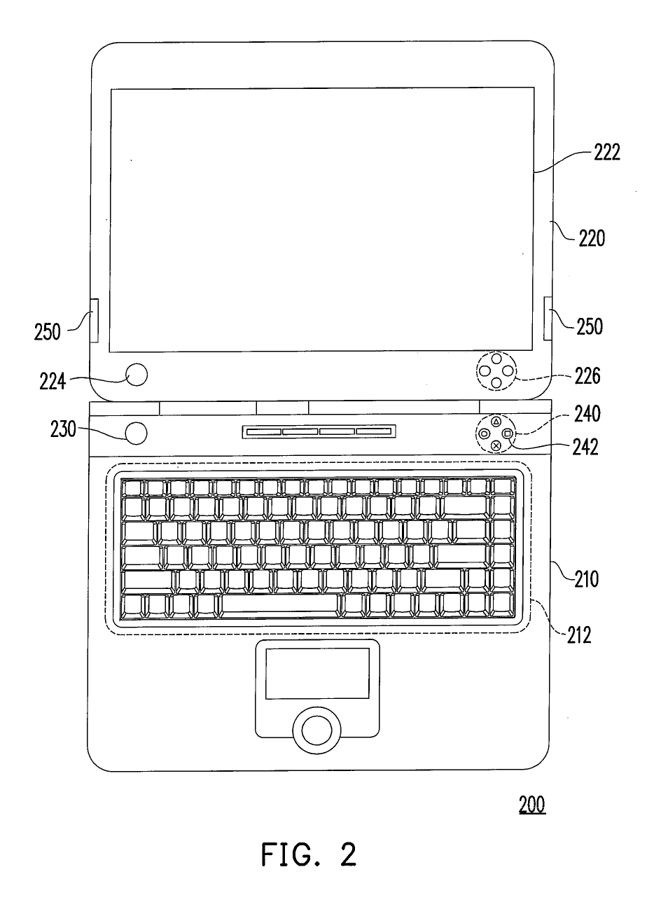

FIG. 2 is a schematic diagram showing the portable computer integrated a direction button and a game-function button according to the first embodiment of the invention. Please refer to FIG. 2, the portable computer integrated a direction button and a game-function button includes a main body 210, a display 220, a direction button 230 and a button set 240. In this embodiment, the portable computer 200 integrated with a direction button and a game-function button is a notebook. In other embodiments the portable computer 200 integrated with a direction button and a game-function button also can be a tablet personal computer, a palmtop, or a UMPC.

The main body 210 is for processing electronic data in the portable computer 200 integrated with a direction button and a game-function button. For example, when users playing video games or using use engineering drawing software, they execute application programs or perform mathematical calculations of electronic data through the main body 210. The keyboard area 212 is provided at the main body 210 for users to input required data or perform some particular functions. The display 220 pivotally connected to the main body 210 has a display area 222 for displaying the output of the electronic data processing of the main body 210, so that the users can know the results of the executions of the application programs or the function options.

The direction button 230 is provided at the main body 210. A corresponding control signal is generated to control the moving direction of the character in the computer games when users pressing the direction button 230 upward, downward, leftward, and rightward. In this embodiment, the direction button 230 is provided at the surrounding of the keyboard area 212 between the keyboard area 212 and the hinge connecting the main body 210 and the display 220. A first concave portion 224 is optionally provided at the display 220 near the hinge connecting the main body 210 and the display 220. The position of the first concave portion 224 corresponds to the direction button 230, so that the direction button 230 can be received in the first concave portion 224 and not be pressed by the display 220 when the display 220 of the portable computer 200 is closed relatively to the main body 210.

The button set 240 is provided at the main body 210, and include four function buttons 242 arranged upward, downward, leftward and rightward. When users pressing one of the function buttons 242, a corresponding control signal is generated to perform a corresponding particular function of the function buttons 242, such as jumping, attacking, menu switching, accelerating, and so on. In this embodiment, the button set 240 is provided at the surrounding of the keyboard area 212 between the keyboard area 212 and the hinge connecting the main body 210 and the display 220. The direction button 230 and the button set 240 are respectively provided at the two ends of the main body to let users operate conveniently. Similarly, a plurality of second concave portions 226 are optionally provided at the display 220 near the hinge connecting the main body 210 and the display 220. The positions of the second concave portions 226 correspond to the function buttons 242, so that the direction buttons 242 can be received respectively in the second concave portions 226 and not be pressed by the display 220 when the display 220 of the portable computer 200 integrated a direction button and a game-function button is closed relatively to the main body 210.

Additionally, in order to let roles in the computer games have more different actions and promote the interesting of the computer games, a lateral function button 250 is optionally provided at a side surface of the display 220 near the hinge connecting the main body 210 and the display 220 to process the corresponding particular function of the lateral function button 250, for example, pressing one of the lateral function buttons 250 can control hand actions or foot actions of the roles in the computer games.

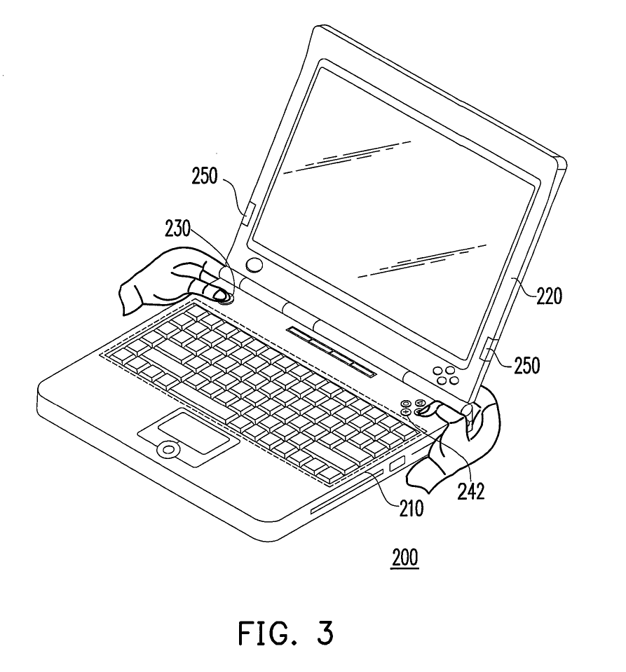

Please refer to FIG. 3, when users playing computer games on the portable computer 200 integrated a direction button and a game-function button, they can first hold the bottom of the main body 210 near the hinge connecting the main body 210 and the display 220 by hands, and then press the direction button 230, the function button 242, the lateral function button 250, or a combination thereof by their thumbs and forefingers for performing some required functions. Therefore, there is no need to externally connect a joystick unit to the portable computer 200. The users can achieve the agileness and effect of the joystick unit of a conventional game machine.

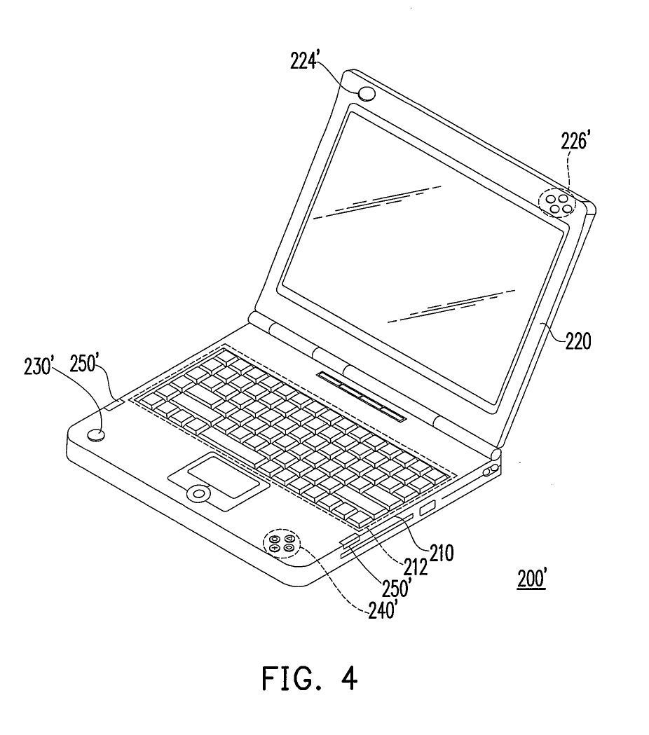

FIG. 4 is a schematic diagram showing a portable computer integrated a direction button and a game-function button according to the second embodiment of the invention. Please refer to FIG. 4, the structure of the portable computer 200′ integrated a direction button and a game-function button is basically the same as the structure of the portable computer 200 integrated a direction button and a game-function button shown in the FIG. 2. However, in this embodiment, a direction button 230′ is provided at the surrounding of the keyboard area 212 away from the hinge connecting the main body 210 and the display 220. Similarly, a button set 240′ is provided at the surrounding of the keyboard area 212 away from the hinge connecting the main body 210 and the display 220, the direction button 230′ and the button set 240′ are respectively provided at the two ends of the main body 210.

When the position of the direction button 230′ changes, the first concave portion 224′ used to receive the direction button 230′ should be adjusted to the position that is on the display 220 away from the hinge connecting the main body 210 and the display 220, so that the direction button 230′ can be received into the first concave portion 224′ and not be pressed by the display 220 when the display 220 of the portable computer 200′ integrated with a direction button and a game-function button is closed relatively to the main body 210. Similarly, the second concave portion 226′ used to receive the button set 240′ should be adjusted to the position that is on the display 220 away from the hinge connecting the main body 210 and the display 220, thus the button set 240′ can be received into the second concave portion 226′ and not be pressed by the display 220 when the display 220 of the portable computer 200′ integrated a direction button and a game-function button is closed relatively to the main body 210.

Additionally, a lateral function button 250′ is optionally provided at a side surface of the display 220 near the direction button 230′ and the button set 240′ for certain corresponding particular function. For example, pressing one of the lateral function buttons 250 can control the actions of the hands or feet of the characters in the computer games.

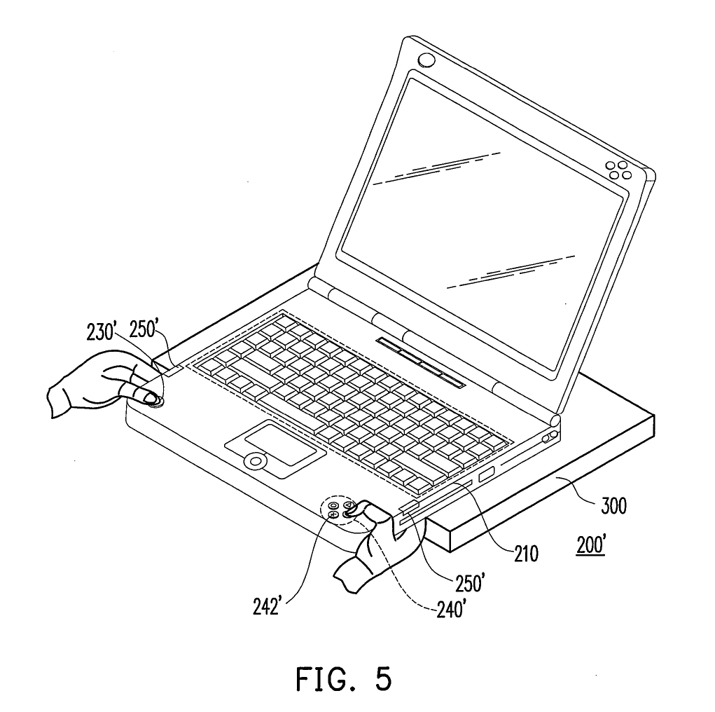

Please refer to FIG. 5, when users playing computer games on the portable computer 200′ integrated the direction button and the game-function button, users can first put the portable computer 200′ integrated the direction button and the game-function button on a table 300′, and let the portion of the main body 210 having the direction button 230′ and the button set 240′ be positioned beyond the edge of the table 300′, so that a user can press the direction button 230′, the function buttons 242′, the lateral function button 250′, or a combination thereof by his thumb and forefinger to perform some functions.

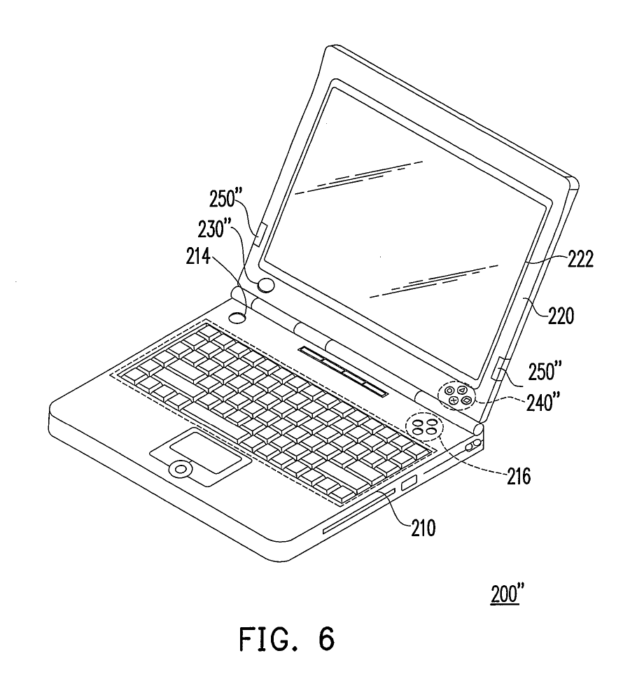

FIG. 6 is a schematic diagram showing a portable computer integrated with a direction button and a game-function button according to the third embodiment of the invention. Please refer to FIG. 6, the structure of the portable computer 200′ integrated with a direction button and a game-function button has basically the same as the structure of the portable computer 200 integrated with a direction button and a game-function button shown in the FIG. 2. However, in this embodiment, a direction button 230″ is provided at the display 220 at the surrounding of the display area 222 near the hinge connecting the main body 210 and the display 220. Similarly, a button set 240″ is also provided at the surrounding of the display area 222 near the hinge connecting the main body 210 and the display 220. The direction button 230″ and the button set 240″ are respectively provided at the two ends of the display 220.

When the position of the direction button 230″ changes, the first concave portion 214 used to receive the direction button 230″ should also be adjusted to the position that is on the main body 210 near the hinge connecting the main body 210 and the display 220 and corresponds to the direction button 230″. Thus the direction button 230″ can be received into the first concave portion 214 and not be pressed by the main body 210 when the display 220 of the portable computer 200″ integrated with a direction button and a game-function button is closed relatively to the main body 210. Similarly, the second concave portion 216 used to receive the button set 240″ should be adjusted to the position that is on the main body 210 near the hinge connecting the main body 210 and the display 220 and corresponds to the button set 240″. Thus the button set 240″ can be let into the second concave portion 216 and not be pressed by the main body 210 when the display 220 of the portable computer 200″ integrated a direction button and a game-function button closing relatively to the main body 210.

Additionally, a lateral function button 250″ is optionally provided at a further edge of the display 220 near the direction button 230″ and the button set 240″ to process the corresponding particular function of the lateral function button 250′, for example, pressing one of the lateral function buttons 250 can control hand actions or foot actions of the roles in the computer games.

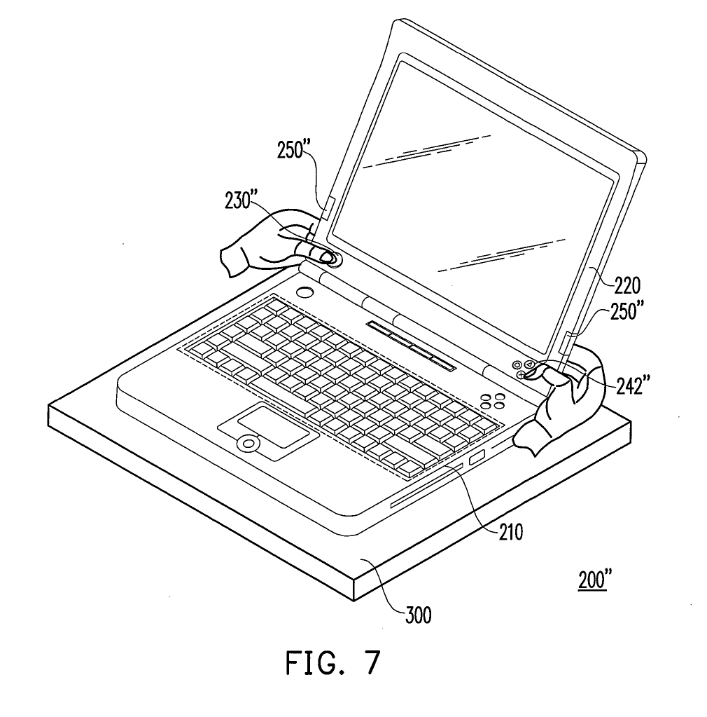

Please refer to FIG. 7, when users playing computer games on the portable computer 200″ integrated with the direction button and the game-function button, the users can first put the portable computer 200″ integrated with the direction button and the game-function button on the table 300 and put a hand behind the display 220 near the hinge connecting the main body 210 and the display 220. Doing this, they can press the direction button 230″, the function buttons 242″, the lateral function button 250′, or a combination thereof directly by their thumbs and forefingers to perform some required functions.

In summary, in a preferred embodiment of the invention, the direction button and the button set are provided at the main body or the display of the portable computer integrated the direction button and the game-function button. Thus users can press the direction button and the button set of the portable computer integrated with the direction button and the game-function button directly for performing the required functions when they play computer games on the portable computer integrated with the direction button and the game-function button. Therefore, there is no need to externally connect a joystick unit to the portable computer, and users can achieve the agileness and effect of the joystick unit of conventional game machines and the portability also can be increased.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A portable computer integrated with a direction button and a function button set comprising:
a main body for processing electronic data, the main body having a keyboard area;
a display pivotally connected to one side of the main body for displaying the result of the electronic data processing;
a direction button provided at the main body, wherein the direction button is provided at the surrounding of the keyboard area, and is provided between the keyboard area and the hinge connecting the main body and the display; and
a button set provided at the main body, the button set further comprising a plurality of function buttons, wherein the button set is provided at the surrounding of the keyboard area, and is provided between the keyboard area and a hinge connecting the main body and the display.

2. The portable computer according to claim 1, further comprising a plurality of lateral function buttons which are provided at the surrounding of the display near the hinge connecting the main body and the display.

3. The portable computer according to claim 1, wherein the display has a first concave portion near the hinge connecting the main body and the display, the first concave portion corresponds to the direction button.

4. The portable computer according to claim 1, wherein the display has a plurality of second concave portions near the hinge connecting the main body and the display, the second concave portions respectively correspond to the function buttons.

5. A portable computer integrated with a direction button and a game-function button, comprising:
a main body for processing electronic data, the main body having a keyboard area;
a display pivotally connected to one side of the main body for displaying the result of the electronic data processing;
a direction button provided at the main body, wherein the direction button is provided at the surrounding of the keyboard area away from the hinge connecting the main body and the display; and
a button set provided at the main body, the button set further comprising a plurality of function buttons, wherein the button set is provided at the surrounding of the keyboard area away from the hinge connecting the main body and the display.

6. The portable computer according to claim 5, further comprising a plurality of lateral function buttons provided at the surrounding of the main body.

7. The portable computer according to claim 5, wherein the display has a first concave portion far from the hinge connecting the main body and the display, and the first concave portion corresponds to the direction button.

8. The portable computer according to claim 5, wherein the display has a plurality of second concave portions far from the hinge connecting the main body and the display, and the second concave portions respectively correspond to the function buttons.

9. A portable computer integrated a direction button and a game-function button, comprising:
a main body for processing electronic data;
a display pivotally connected to one side of the main body, the display having a display area for displaying the result of the electronic data processing;
a direction button provided at the display, wherein the direction button is provided at the surrounding of the display area near the hinge connecting the main body and the display; and
a button set provided at the display, the button set further comprising a plurality of function buttons, wherein the button set is provided at the surrounding of the display area near the hinge connecting the main body and the display.

10. The portable computer according to claim 9, further comprising a plurality of lateral function buttons provided at the surrounding of the display.

11. The portable computer according to claim 9, wherein the main body has a first concave portion near the hinge connecting the main body and the display, and the first concave portion corresponds to the direction button.

12. The portable computer according to claim 9, wherein the main body has a plurality of second concave portions near the hinge connecting the main body and the display, and the second concave portions respectively corresponds to the function buttons.
